(19) United States
(12) Patent Application Publication
(10) Pub. No.: US 2008/0224349 A1
(43) Pub. Date: Sep. 18, 2008

(54) Methods for Manufacturing Multi-Layer Rotationally Molded Parts

(76) Inventors: Jing Wang, Simpsonville, SC (US); Blair A. Graham, Bright's Grove (CA); Anne-Marie C. Forcum, Rensselaer, NY (US); Paul R. Willey, Clifton Park, NY (US)

Correspondence Address: GOODWIN PROCTER LLP;PATENT ADMINISTRATOR, EXCHANGE PLACE, BOSTON, MA, 02109-2881, US

(21) Appl. No.: 11/935,071

(22) Filed: Nov. 5, 2007

Related U.S. Application Data
(60) Provisional application No. 60/856,459, filed on Nov. 3, 2006.

(51) Int. Cl. B29C 65/80

(52) U.S. Cl. 264/241

(57) ABSTRACT

This invention relates generally to methods of rotationally molding multi-layer parts. More particularly, in certain embodiments, the invention relates to methods of manufacturing a part having an interior layer of polymerized macrocyclic polyester oligomer and an exterior layer of a substantially non-oligomeric polymer. The invention also relates to methods of manufacturing a part with a scratch resistant surface.

### PRIOR APPLICATION

This application claims priority to and benefit under 35 U.S.C. 119(e) of U.S. Provisional Patent Application No. 60/856,459, filed Nov. 3, 2006, the text of which is incorporated herein by reference in its entirety.

### FIELD OF THE INVENTION

This invention relates generally to methods of rotationally molding multiple-layer parts. More particularly, in certain embodiments, the invention relates to the rotational molding of a multi-layer part using a single charge containing macrocyclic polyester oligomer and non-oligomeric polymer.

### BACKGROUND OF THE INVENTION

Multiple-layer manufactured parts are useful, for example, where it is desired that properties of the interior and exterior of the part differ, or where it is only necessary that one layer be made from a special material, while the remainder of the part can be made of less expensive material.

For example, double layer gasoline tanks (or other fuel tanks) may be manufactured with an interior layer having very low gasoline (or other fuel) permeability and with an exterior layer that has high impact resistance. Such parts may be rotationally molded.

The manufacture of multiple-layer parts typically requires multiple charges. For example, a rotational mold is charged with polymer granules, which are melted and rotated, then cooled, thereby forming the outer layer of a two-layer part. Then, a different polymer is fed into the mold, rotated, and cooled to form the inner layer. The inner polymer may have a lower melting point than the outer polymer, and the interior temperature of the mold in the second step may be held between the melting points of the two polymers so that the outer layer stays solid while the inner layer is being rotationally molded.

Drop boxes have been used to simplify the rotational molding of multi-layer parts with multiple charges. The drop box usually mounts on the outside of the mold and holds a second charge of material. After the first charge inside the mold cavity has formed the exterior layer of the molded part, an air actuated cylinder inside the drop box releases the second charge into the mold to form the interior layer. Drop box methods are still more complex than single charge processes, and generally require more processing time.

Single charge processing is possible where the outer layer polymer has a lower melting temperature than the inner layer polymer. It is possible to charge the rotational mold with particles of both polymers, then heat and rotate the mold to form the part from the single charge. The particles of the outer layer polymer melt first and stick to the wall of the mold while the particles of the inner layer polymer remain solid. Then, the inner layer polymer melts and rotation continues until an even interior coating is achieved.

However, in practice, particles of the inner layer polymer can become trapped in the outer layer, and a greater amount of inner layer polymer is needed to form an even interior coating. This is particularly problematic where the inner layer polymer is an expensive material. Furthermore, the properties of the part, including its appearance, may be adversely affected by the presence of interior layer polymer trapped in the outer layer. For example, there may be gaps or ruptures within the part or at the exterior or interior surfaces of the part due to the trapped material.

Single-charge rotational molding processes are less expensive to run than multiple-charge processes because they require less time and are less complex. However, the problem of entrapment of inner layer polymer in the outer layer may require using more of the expensive inner layer polymer. The entrapped polymer may also have deleterious effects on the appearance and/or function of the manufactured part.

Thus, there is a need for efficient methods of manufacturing multi-layer parts with reduced entrapment of polymer particles between the layers.

### SUMMARY OF THE INVENTION

A double-layered fuel tank or other multi-layer part can be rotationally molded with a tough, durable exterior and with an interior having very low gasoline (or other fluid) permeability, where the interior layer is made from a macrocyclic polyester oligomer (MPO), and the exterior layer is made from a non-oligomeric polymer such as polyethylene. The polymerized MPO layer provides extremely low gasoline permeability on the interior of the part, while the molded polyethylene (optionally cross-linked) provides an inexpensive, durable exterior.

In a preferred embodiment, a rotational mold is initially charged with both an MPO and a non-oligomeric polymer. The invention substantially reduces or eliminates entrapment of polymer particles in rotationally molded multi-layer parts, without requiring that the mold be separately charged with material to build each layer. The problem of entrapped particles is solved by: (i) initially charging the mold with the interior layer material contained inside a plastic bag; and/or (ii) initially charging the mold with the interior layer material in the form of particles that are sufficiently large and/or heavy to prevent them from sticking in the melting exterior layer material.

For example, in one embodiment, a rotational mold is initially charged with solid polyethylene particles as well as solid MPO particles, wherein the MPO particles are contained within a plastic bag and/or the MPO particles are sufficiently large that they do not stick in the melting polyethylene during mold rotation.

Where a plastic bag is used, release of the MPO is delayed during the rotational molding cycle, allowing the substantially non-oligomeric polymer (e.g., polyethylene) to partially or completely melt, coat the interior of the mold, and/or cross-link. The delayed release prevents or reduces embedding of the MPO in the exterior polyethylene layer. The plastic bag becomes incorporated in the part without detrimental effects.

The plastic bag may be any plastic container of any configuration. One or more plastic bags may be used, and/or the characteristics of the bag may be tailored to a given process to provide an adequately delayed release of melted/melting MPO (e.g. bag thickness, material, weave, etc., can be varied). Parts with two or more layers may be manufactured, for example, by charging the mold with different bags containing different layer materials, the bags having different melt or rupture characteristics such that their contents are released at different times during the rotational molding cycle, thereby allowing greater control of the distribution of materials within different layers. For example, the more interior layers may be initially contained in bags that melt or rupture later in the cycle.

The plastic bag(s) may contain fillers, including catalysts, cross-linking agents, and/or reinforcing agents to be used in one or more separate layers. For example, a rotational mold can be initially charged with a stone-filled cyclic poly(butylene terephthalate) oligomer (cPBT) with polymerization catalyst to form the outer layer of the part, and at the same time, the rotational mold is also charged with a plastic bag containing glass fiber reinforcement and oligomer or polymer to form the inner layer. The outer stone-filled layer provides good aesthetics, while the glass-filled layer provides strength.

Using MPO particles having an average thickness greater than the thickness of the outer layer of the multi-layer part reduces or eliminates the problem of embedded MPO in the outer layer. For example, in an embodiment where the particles are roughly spherical, the MPO particles used may have average radius greater than the thickness of the outer layer. For example, where the outer layer is made with polyethylene and the inner layer is made with cyclic poly(butylene terephthalate) oligomer (cPBT), the size and weight of the cPBT particles pulls them out of the melted/melting polyethylene layer as the mold rotates, avoiding or preventing entrapment.

These large particles are optionally contained within a plastic bag upon initial charging of the mold, to delay release of the MPO and molding of the MPO layer. In certain embodiments, the large particles are not contained within a plastic bag, but are simply introduced into the mold along with the exterior layer material before rotational molding begins. The MPO particles are preferably large and/or heavy enough to “pull out” of the melting exterior layer material as the mold rotates early in the cycle. Then, as the MPO particles melt, the MPO polymerizes in the mold to form the interior layer of the part.

The rotational molding methods described herein are not limited to use of MPO. For example, the methods may be used to manufacture multi-layer parts with polyethylene in one layer and one or more other plastics, such as nylon, in another layer.

The plastic bag may also be used to control the release of MPO in making thick walled parts, for example, parts over about ⅛″ [3 mm] thick. Rotational molding of a large amount of MPO resin, for example, cyclic poly(butylene terephthalate) oligomer, at one time may lead to uneven wall thickness distribution in rotationally molded parts. One or more plastic bags may be used to control the release of MPO at different times and temperatures. By effectively dividing one charge into several small charges in the mold, the wall thickness distribution is improved. Thus, both release and coverage of an inner resin layer of the rotationally molded part can be controlled using sacrificial plastic containers in a single charge.

Where the exterior layer material is polyethylene (PE) and the MPO is cyclic poly(butylene terephthalate) oligomer (cPBT), the PE melts at about 120° C. while the cPBT starts melting at about 160° C. When the PE begins to melt, it adheres to the wall of the mold, while the cPBT is still solid and is rolling in the mold. The use of a bag to initially contain the cPBT helps prevent the cPBT particles becoming trapped in the PE layer. Alternatively, or additionally, the use of large and/or heavy cPBT particles helps the cPBT “pull out” of the melting PE layer as the mold rotates, for at least part of the time during which the PE layer is being formed.

In addition to providing low fluid permeability, a layer made with polymerized MPO offers excellent scratch resistance. Thus, in one embodiment, the invention provides a method of rotationally molding a multi-layer part using a single initial charge of (i) an MPO for forming the exterior layer with scratch resistant surface and (ii) a substantially non-oligomeric polymer for forming an interior layer. Various embodiments make use of a plastic bag containing the non-oligomeric polymer for delayed release and/or better controlled coverage, allowing the MPO to coat the mold before release of non-oligomeric polymer.

Additionally or alternatively, melted MPO can be used to coat particles of the interior layer non-oligomeric polymer (e.g., polyethylene particles). The melted MPO may or may not contain catalyst, and even if it contains catalyst, the MPO should not polymerize significantly during the coating process, as coating requires low residence time and relatively low temperature. The coated polyethylene particles may then be placed in a rotational mold in a single charge with the MPO. The MPO polymerizes to form a scratch-resistant outer layer with the polyethylene dispersed therein, thereby improving impact strength.

In one aspect, the invention relates to a method of manufacturing a multi-layer part, the method including the steps of: (a) charging a rotational mold with at least a substantially non-oligomeric polymer and a macrocyclic polyester oligomer, wherein the macrocyclic polyester oligomer is initially contained within one or more plastic bags; and (b) rotating the mold, the mold having an elevated interior temperature.

The substantially non-oligomeric polymer may include one or more of the following: polyethylene, polybutylene, polypropylene, polystyrene, polyethylene terephthalate, polybutylene terephthalate, polyamide, polyester, polyvinyl chloride, polycarbonate, acrylonitrile butadiene styrene, nylon, polyurethane, polyacetal, and/or polyvinylidene chloride, for example. The substantially non-oligomeric polymer may include a crosslinked polymer, for example, crosslinked polyethylene, and/or a thermoplastic polyolefin.

The macrocyclic polyester oligomer may include a macrocyclic poly(alkylene dicarboxylate) oligomer having a structural repeat unit of the formula:

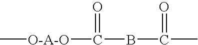

where A is an alkylene, or a cycloalkylene or a mono- or polyoxyalkylene group; and B is a divalent aromatic or alicyclic group. For example, the macrocyclic polyester oligomer may include one or more of the following: macrocyclic poly(butylene terephthalate) oligomer, macrocyclic poly(propylene terephthalate) oligomer, macrocyclic poly(cyclohexylenedimethylene terephthalate) oligomer, macrocyclic poly(ethylene terephthalate) oligomer, macrocyclic poly(1,2-ethylene 2,6-naphthalenedicarboxylate) oligomer, and copolyester oligomer comprising two or more monomer repeat units.

In a preferred embodiment, the melting temperature of the macrocyclic polyester oligomer is higher than the melting temperature of the non-oligomeric polymer. In certain embodiments, the substantially non-oligomeric polymer includes polyethylene, and the macrocyclic polyester oligomer comprises macrocyclic poly(butylene terephthalate) oligomer.

In certain embodiments, the mold is also initially charged with a filler. The filler may include, for example, one or more of the following: a polymerization catalyst, a cross-linking agent, glass, glass fiber, milled glass fiber, glass microspheres, micro-balloons, stone, crushed stone, nanoclay, graphite, carbon nanotubes, carbon black, carbon fibers, buckminsterfullerene, anhydrous talc, fumed silica, titanium dioxide, calcium carbonate, wollastonite, chopped fiber, fly ash, linear polymer, monomer, branched polymer, engineering resin, impact modifier, organoclay, and/or pigment.

The plastic bag may be made of one or more of the following: polyethylene, high density polyethylene (HDPE), low density polyethylene (LDPE), polylactide, and/or starch (e.g., for biodegradable bags). In certain embodiments, during step (b), the macrocyclic polyester oligomer (MPO) begins to melt before the plastic bag. Furthermore, in certain embodiments, the substantially non-oligomeric polymer begins to melt before the MPO and before the plastic bag.

The interior air temperature of the mold may reach at least about 200° C. during step (b), wherein the substantially non-oligomeric polymer begins to melt at about 120° C., and wherein the macrocyclic polyester oligomer begins to melt at a temperature above about 120° C. In certain embodiments, the interior air temperature of the mold reaches at least about 220° C., about 230° C., about 240° C., or about 250° C. In certain embodiments, the difference in the melting temperature of the MPO and the substantially non-oligomeric polymer is at least about 20° C., at least about 25° C., at least about 30° C., at least about 35° C., or at least about 40° C.

In a preferred embodiment, step (a) includes charging the rotational mold with the MPO and the substantially non-oligomeric polymer in one step. In alternative embodiments, the rotational mold may be charged in two or more separate steps, and/or may be continuously or semi-continuously charged during the molding process. The description of elements of the embodiments elsewhere herein can be applied in this aspect of the invention as well.

In another aspect, the invention relates to a method of manufacturing a multi-layer part, the method including the steps of: (a) charging a rotational mold with at least the following: a substantially non-oligomeric polymer for forming an exterior layer of the multi-layer part; and particles including MPO for forming an interior layer of the multi-layer part, wherein the particles including the MPO average at least about ⅛″ in at least one dimension; and (b) rotating the mold, the mold having an elevated interior temperature. The description of elements of the embodiments above and elsewhere herein can be applied in this aspect of the invention as well.

In certain embodiments, the particles including the MPO average at least about ¼″, at least about ½″, at least about ¾″, at least about 1″, at least about 1¼″, or at least about 1½″ in at least one dimension. The at least one dimension may include, for example, thickness and/or length (e.g. for pellets or pastilles), and/or diameter and/or radius (e.g., for spherical or roughly spherical particles). In certain embodiments, at least half of the particles including the MPO are larger in at least one dimension than the thickness of the exterior layer of the multi-layer part. The particles may be substantially spherical, substantially cylindrical, and/or the particles may have an irregular shape. In certain embodiments, the particles have an average radius greater than the thickness of the exterior layer of the multi-layer part. In certain embodiments, the particles are sized such that they number about 60 or fewer particles per gram, about 50 or fewer particles per gram, about 40 or fewer particles per gram, about 35 or fewer particles per gram, about 30 or fewer particles per gram, about 25 or fewer particles per gram, about 20 or fewer particles per gram, about 15 or fewer particles per gram, about 10 or fewer particles per gram, about 5 or fewer particles per gram, about 4 or fewer particles per gram, about 3 or fewer particles per gram, about 2 or fewer particles per gram, or about 1 particle per gram.

In certain embodiments, the particles including MPO are contained within one or more plastic bags. For example, in certain embodiments, the substantially non-oligomeric polymer begins to melt before the MPO and before the plastic bag.

In another aspect, the invention relates to a method of manufacturing a multi-layer part, the method including the steps of: (a) charging a rotational mold with at least: (i) a substantially non-oligomeric polymer for forming an exterior layer of the multi-layer part, and (ii) MPO particles for forming an interior layer of the multi-layer part, where the MPO particles have an average thickness greater than the thickness of the exterior layer of the multi-layer part; and (b) rotating the mold, the mold having an elevated interior temperature. The description of elements of the embodiments above and elsewhere herein can be applied in this aspect of the invention as well. In certain embodiments, the MPO particles have an average radius greater than the thickness of the exterior layer of the multi-layer part. In certain embodiments, the substantially non-oligomeric polymer includes one or more of the following: polyethylene, crosslinked polyethylene, polybutylene, polypropylene, polystyrene, polyethylene terephthalate, polybutylene terephthalate, polyamide, polyester, polyvinyl chloride, polycarbonate, acrylonitrile butadiene styrene, nylon, polyurethane, polyacetal, and polyvinylidene chloride.

In yet another aspect, the invention relates to a method of manufacturing a part with a scratch-resistant outer surface, the method including the steps of: (a) charging a rotational mold with at least a substantially non-oligomeric polymer and an MPO for forming the scratch-resistant surface of the part, wherein the substantially non-oligomeric polymer is initially contained within a plastic bag; and (b) rotating the mold, the mold having an elevated interior temperature, wherein the MPO begins to melt before the plastic bag. The description of elements of the embodiments above and elsewhere herein can be applied in this aspect of the invention as well.

In still another aspect, the invention relates to a method of manufacturing a part with a scratch-resistant surface, the method including the steps of: (a) coating particles including a substantially non-oligomeric polymer with an at least partially molten MPO; (b) charging a rotational mold with at least the coated particles from step (a); and (c) rotating the mold, the mold having an elevated interior temperature. The description of elements of the embodiments above and elsewhere herein can be applied in this aspect of the invention as well. For example, certain portions of the charge may be bagged and/or large particles may be used to reduce or eliminate intermingling of components of the various layers of the multi-layer part.

In another aspect, the invention relates to a method of manufacturing a part with a scratch-resistant surface, the method comprising the steps of contacting a surface of a rotational mold with melted MPO, then introducing a substantially non-oligomeric polymer into the mold. The description of elements of the embodiments above and elsewhere herein can be applied in this aspect of the invention as well. The step of contacting a surface of the rotational mold with melted MPO may include introducing solid particles made at least partially of MPO into the mold and melting the solid particles in the mold. In another embodiment, the step of contacting the surface of the rotational mold with melted MPO includes introducing melted MPO into the mold. In certain embodiments, the step of introducing a substantially-non-oliogmeric polymer into the mold is performed using a drop box. The drop box may be located outside the mold or inside the mold, for example. In certain embodiments, the drop box mounts on the outside of the mold and holds the substantially non-oligomeric polymer. For example, after the first charge inside the mold cavity (including or consisting of MPO) has coated the interior surface of the mold, an air actuated cylinder inside the drop box releases the second charge into the mold.

### BRIEF DESCRIPTION OF THE DRAWING

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 depicts pellets of cyclic poly(butylene terephthalate) oligomer used in a rotational molding process, according to an illustrative embodiment of the invention.

FIG. 2 depicts pellets of cyclic poly(butylene terephthalate) oligomer sealed in 4 mil polyethylene bags, where a rotational mold is initially charged with the bags, according to an illustrative embodiment of the invention.

FIG. 3 depicts a rotational mold initially charged with polyethylene powder and bagged cyclic poly(butylene terephthalate) oligomer, according to an illustrative embodiment of the invention.

FIG. 4 depicts a two-layer rotationally molded part made with the mold initially charged with bagged MPO, and a part made with the mold initially charged with unbagged MPO, according to illustrative embodiments of the invention.

### DETAILED DESCRIPTION

Throughout the description, where reagents, reactants, and products are described as having, including, or comprising one or more specific components, or where processes and methods are described as having, including, or comprising one or more specific steps, it is contemplated that, additionally, there are reagents, reactants, and products of the present invention that consist essentially of, or consist of, the one or more recited components, and that there are processes and methods according to the present invention that consist essentially of, or consist of, the one or more recited processing steps.

It should be understood that the order of steps or order for performing certain actions is immaterial, as long as the invention remains operable. Moreover, two or more steps or actions may be conducted simultaneously.

Scale-up and/or scale-down of systems, processes, units, and/or methods disclosed herein may be performed by those of skill in the relevant art. Processes described herein are generally configured for batch operation, but also include continuous or semi-continuous processes.

The headers are provided herein as a general organizational guide and do not serve to limit support for any given element of the invention to a particular section of the specification.

### DEFINITIONS

As used herein, “macrocyclic” is understood to mean a cyclic molecule having at least one ring within its molecular structure that contains 5 or more atoms covalently connected to form the ring.

As used herein, an “oligomer” is understood to mean a molecule that contains from two to seven identifiable structural repeat units of the same or different formula.

As used herein, a “non-oligomeric polymer” is understood to mean a polymer that contains at least 8 structural repeat units of the same or different formula. The physical properties of an oligomer generally vary with the addition or removal of one of the structural repeat units, while the physical properties of a non-oligomeric polymer generally do not appreciably vary with the addition or removal of one of the structural repeat units.

As used herein, a “macrocyclic polyester oligomer” (MPO) is understood to mean a macrocyclic oligomer containing structural repeat units having an ester functionality. A macrocyclic polyester oligomer typically refers to multiple molecules of one specific repeat unit formula. However, a macrocyclic polyester oligomer also may include multiple molecules of different or mixed formulae having varying numbers of the same or different structural repeat units. In addition, a macrocyclic polyester oligomer may be a co-polyester or multi-component polyester oligomer, i.e., an oligomer having two or more different structural repeat units having ester functionality within one cyclic molecule.

As used herein, “substantially homo- or co-polyester oligomer” is understood to mean a polyester oligomer wherein the structural repeat units are substantially identical or substantially composed of two or more different structural repeat units, respectively.

As used herein, an “alkylene group” is understood to mean —CₐH₂ₙ—, where n≧2.

As used herein, a “cycloalkylene group” is understood to mean a cyclic alkylene group, —CₙH₂ₙ₋ₓ—, where x represents the number of H's replaced by cyclization(s).

As used herein, a “mono- or polyoxyalkylene group” is understood to mean [—(CH₂)ₘ—O—]ₙ—(CH₂)ₘ—, wherein m is an integer greater than 1 and n is an integer greater than 0.

As used herein, a “divalent aromatic group” is understood to mean an aromatic group with links to other parts of the macrocyclic molecule. For example, a divalent aromatic group may include a meta- or para-linked monocyclic aromatic group (e.g., benzene).

As used herein, an “alicyclic group” is understood to mean a non-aromatic hydrocarbon group containing a cyclic structure within.

As used herein, a “C₁₋₄ primary alkyl group” is understood to mean an alkyl group having 1 to 4 carbon atoms connected via a primary carbon atom.

As used herein, a “C₁₋₁₀ alkyl group” is understood to mean an alkyl group having 1 to 10 carbon atoms, including straight chain or branched radicals.

As used herein, a “methylene group” is understood to mean —CH₂—.

As used herein, an “ethylene group” is understood to mean —CH₂—CH₂—.

As used herein, a “C₂₋₃ alkylene group” is understood to mean —CₙH₂ₙ—, where n is 2 or 3.

As used herein, a “C₂₋₆ alkylene group” is understood to mean —CₙH₂ₙ—, where n is 2-6.

As used herein, “substitute phenyl group” is understood to mean a phenyl group having one or more substituents. A substituted phenyl group may have substitution pattern that is recognized in the art. For example, a single substituent may be in the ortho, meta or para positions. For multiple substituents, typical substitution patterns include, for example, 2,6-, 2,4,6-, and, 3,5-substitution patterns.

As used herein, a “filler” is understood to mean a material added to a macrocyclic polyester oligomer and/or non-oligomeric polymer in manufacturing a part. A filler may be used to achieve a desired purpose or property (e.g., physical, mechanical, chemical, electrical, and/or thermal property(ies)), and may be present or transformed into known and/or unknown substances in the resulting part. For example, the purpose of the filler may be to provide stability, such as chemical, thermal, or light stability; to increase the strength of the part (or layer thereof); and/or to increase electrical and/or thermal conductivity of the part (or layer thereof). A filler also may provide or reduce color, provide weight or bulk to achieve a particular density, provide reduced gas, liquid, and/or vapor permeability, provide flame or smoking resistance (i.e., be a flame retardant), be a substitute for a more expensive material, facilitate processing, and/or provide other desirable properties. Illustrative examples of fillers are, among others, polymerization catalysts, cross-linking agents, graphite, carbon nanotubes, carbon black, carbon fibers, anhydrous magnesium silicate (anhydrous talc), fumed silica, titanium dioxide, calcium carbonate, aluminum (e.g., aluminum powder), wollastonite, chopped fibers, fly ash, glass, glass fiber, milled glass fiber, microspheres (e.g., glass or polymeric; hollow, partially hollow, or filled), nanospheres (e.g., glass or polymeric; hollow, partially hollow, or filled), micro-balloons, crushed stone, nanoclay, linear polymers, monomers, branched polymers, engineering resin, impact modifiers, organoclays, and pigments. Multiple fillers may be included, for example, to achieve a balance of properties.

### Macrocyclic Polyester Oligomers

Many different MPOs can readily be made and are useful in the practice of this invention. MPOs that may be employed in this invention include, but are not limited to, macrocyclic poly(alkylene dicarboxylate) oligomers having a structural repeat unit of the formula:

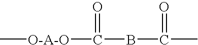

where A is an alkylene, or a cycloalkylene or a mono- or polyoxyalkylene group; and B is a divalent aromatic or alicyclic group.

Preferred MPOs include macrocyclic poly(1,4-butylene terephthalate) (cPBT), macrocyclic poly(1,3-propylene terephthalate) (cPPT), macrocyclic poly(1,4-cyclohexylenedimethylene terephthalate) (cPCT), macrocyclic poly(ethylene terephthalate) (PET), and macrocyclic poly(1,2-ethylene 2,6-naphthalenedicarboxylate) (cPEN) oligomers, and copolyester oligomers comprising two or more of the above monomer repeat units.

MPOs may be prepared by known methods. Synthesis of the preferred MPOs may include the step of contacting at least one diol of the formula HO-A-OH with at least one diacid chloride of the formula:

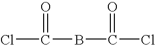

where A and B are as defined above. The reaction typically is conducted in the presence of at least one amine that has substantially no steric hindrance around the basic nitrogen atom. An illustrative example of such amines is 1,4-diazabicyclo[2.2.2]octane (DABCO). The reaction usually is conducted under substantially anhydrous conditions in a substantially water immiscible organic solvent such as methylene chloride. The temperature of the reaction typically is between about −25° C. and about 25° C. See, e.g., U.S. Pat. No. 5,039,783 to Brunelle et al.

MPOs have also been prepared via the condensation of a diacid chloride with at least one bis(hydroxyalkyl) ester such as bis(4-hydroxybutyl) terephthalate in the presence of a highly unhindered amine or a mixture thereof with at least one other tertiary amine such as triethylamine, in a substantially inert organic solvent such as methylene chloride, chlorobenzene, or a mixture thereof. See, e.g., U.S. Pat. No. 5,231,161 to Brunelle et al.

Another method for preparing MPOs is to depolymerize linear polyester polymers in the presence of an organotin or titanate compound. In this method, linear polyesters are converted to macrocyclic polyester oligomers by heating a mixture of linear polyesters, an organic solvent, and a trans-esterification catalyst such as a tin or titanium compound. The solvents used, such as o-xylene and o-dichlorobenzene, usually are substantially free of oxygen and water. See, e.g., U.S. Pat. Nos. 5,407,984 to Brunelle et al. and 5,668,186 to Brunelle et al.

MPOs have been prepared from intermediate molecular weight polyesters by contacting a dicarboxylic acid or a dicarboxylate in the presence of a catalyst to produce a composition comprising a hydroxyalkyl-terminated polyester oligomer. The hydroxyalkyl-terminated polyester oligomer is heated to produce a composition comprising an intermediate molecular weight polyester which preferably has a molecular weight between about 20,000 Daltons and about 70,000 Daltons. The intermediate molecular weight polyester is heated and a solvent is added prior to or during the heating process to produce a composition comprising an MPO. See, e.g., U.S. Pat. No. 6,525,164, to Faler.

MPOs that are substantially free from macrocyclic co-oligoesters have been prepared by depolymerizing polyesters using the organo-titanate catalysts described in U.S. Pat. No. 6,787,632, by Phelps et al. It is also within the scope of the invention to employ macrocyclic homo- and co-polyester oligomers to produce homo- and co-polyester polymers, respectively. Therefore, unless otherwise stated, an embodiment of a composition, article, process, or method that refers to a macrocyclic polyester oligomer also includes a co-polyester embodiments.

In one embodiment, macrocyclic ester homo- and co-oligomers used in this invention include oligomers having a general structural repeat unit of the formula:

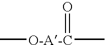

where A′ is an alkylene, cycloalkylene, or mono- or polyoxyalkylene group, and where A′ may be substituted, unsubstituted, branched, and/or linear. Example MPOs of this type include butyrolactone and caprolactone, where the degree of polymerization is one, and 2,5-dioxo-1,4-dioxane, and lactide, where degree of polymerization is two. The degree of polymerization may alternatively be 3, 4, 5, or higher.

In one embodiment, a macrocyclic polyester oligomer (MPO) includes species of different degrees of polymerization. Here, a degree of polymerization (DP) with respect to the MPO means the number of identifiable structural repeat units in the oligomeric backbone. The structural repeat units may have the same or different molecular structure. For example, an MPO may include dimer, trimer, tetramer, pentamer, and/or other species.

### MPO Polymerization Catalyst

Polymerization catalysts employed in certain embodiments of the invention are capable of catalyzing the polymerization of MPO. As with state-of-the-art processes for polymerizing MPOs, organotin and organotitanate compounds are the preferred catalysts, although other catalysts may be used. For example, butyltin chloride dihydroxide (i.e. n-butyltin(IV) chloride dihydroxide) may be used as polymerization catalyst. Other illustrative organotin compounds include dialkyltin(IV) oxides, such as di-n-butyltin(IV) oxide and di-n-octyltin oxide, and acyclic and cyclic monoalkyltin (IV) derivatives such as n-butyltin tri-n-butoxide, dialkyltin(IV) dialkoxides such as di-n-butyltin(IV) di-n-butoxide and 2,2-di-n-butyl-2-stanna-1,3-dioxacycloheptane, and trialkyltin alkoxides such as tributyltin ethoxide. Another illustrative organotin compound that may be used as polymerization catalyst is 1,1,6,6-tetra-n-butyl-1,6-distanna-2,5,7,10-tetraoxacyclodecane. See, e.g., U.S. Pat. No. 5,348,985 to Pearce et al.

Also, trisstannoxanes having the general formula (I) shown below can be used as a polymerization catalyst to produce branched polyester polymers.

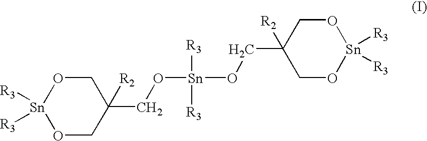

where R₂ is a C₁₋₄ primary alkyl group and R₃ is C₁₋₁₀ alkyl group.

Additionally, organotin compounds with the general formula (II) shown below can be used as a polymerization catalyst to prepare branched polyester polymers from macrocyclic polyester oligomers.

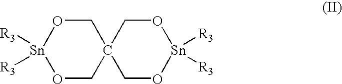

where R₃ is defined as above.

As for titanate compounds, tetra(2-ethylhexyl) titanate, tetraisopropyl titanate, tetrabutyl titanate, and titanate compounds with the general formula (III) shown below can be used as polymerization catalysts.

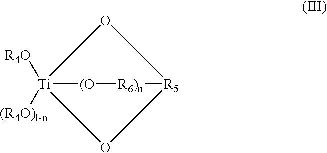

wherein: each R₄ is independently an alkyl group, or the two R₄ groups taken together form a divalent aliphatic hydrocarbon group; R₅ is a C₂₋₁₀ divalent or trivalent aliphatic hydrocarbon group; R₆ is a methylene or ethylene group; and n is 0 or 1.

Typical examples of titanate compounds with the above general formula are shown in Table 1.

TABLE 1
Examples of Titanate Compounds Having Formula (III)

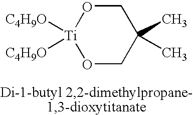

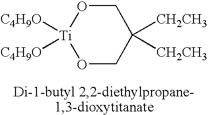

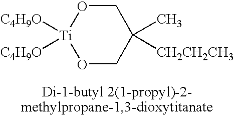

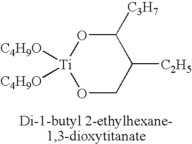

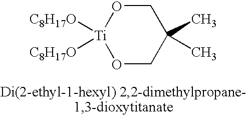

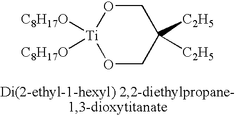

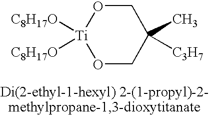

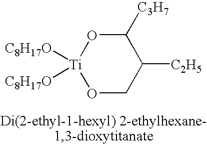

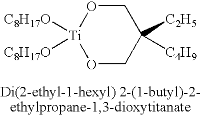

Titanate ester compounds having at least one moiety of the following general formula have also been used as polymerization catalysts:

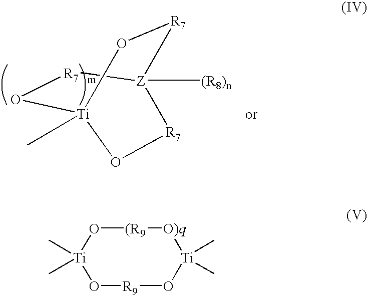

wherein: each R₇ is independently a C₂₋₃ alkylene group; R₈ is a C₁₋₆ alkyl group or unsubstituted or substituted phenyl group; Z is O or N; provided when Z is O, m=n=0, and when Z is N, m=0 or 1 and m+n=1; each R₉ is independently a C₂₋₆ alkylene group; and q is 0 or 1.

Typical examples of such titanate compounds are shown below as formula (VI) and formula (VII):

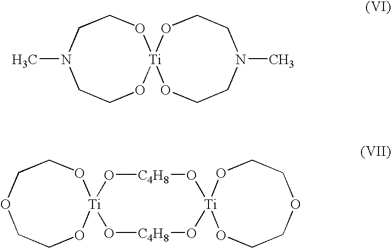

Other polymerization catalysts which may be used include aryl titanates, described, for example, in U.S. Pat. No. 6,906,147, by Wang. Also, polymer-containing organo-metal catalysts may be used in the invention. These include the polymer-containing catalysts described in U.S. Pat. No. 6,831,138, by Wang.

### EXPERIMENTAL EXAMPLES

The experimental examples demonstrate manufacture of multi-layer parts via single-charge rotational molding. The parts include an interior layer containing polymerized MPO and an exterior layer containing polyethylene.

The experiments use solid pellets of macrocyclic polyester oligomer manufactured by Cyclics Corporation of Schenectady, N.Y., that are primarily composed of macrocyclic poly(1,4-butylene terephthalate) oligomer. The MPO used in the experiments is sold as CBT160® and is referred to hereinbelow as cPBT, for simplicity. The pellets also contain 0.5 wt. % Fascat® 4105 organotin polymerization catalyst, manufactured by Arkema, Inc., of Philadelphia, Pa. The pellets are approximately ¼″ long and approximately ⅛″ in diameter.

The experiments also use solid polyethylene (PE) powder manufactured by ExxonMobil Chemical of Ontario, Canada, sold as ExxonMobil HDP8660. The powder has 95% of the particles smaller than about 500 micron (about 35 mesh).

Two-Layer Rotationally Molded Part: PE and Unbagged cPBT Vs. PE and Bagged cPBT

A double-layer box with approximate dimensions 14″×10″×3.5″ was rotomolded with a single charge containing PE and cPBT. Experiments were conducted both with and without the use of a bag to initially contain the cPBT resin, then compared visually.

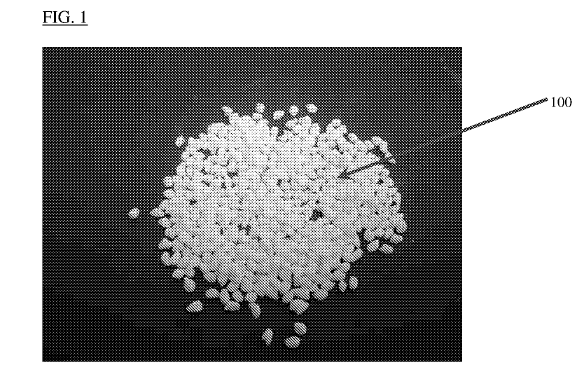

The cPBT pellets were dried in an 80° C. desiccant dryer for at least 20 hours. The rotational mold was charged with approximately 500 g of polyethylene powder (ExxonMobil HDP8660) and approximately 500 g of unbagged, dried cPBT pellets, which are shown in FIG. 1 (100).

The rotomolding oven was preheated to 315° C. and the mold rotated at 4 rpm and 2.5 rpm on the major and minor axes, respectively. The experiment uses a ROTO-Lab Model 30 rotational molding machine, manufactured by MedKeff-Nye Company of Barberton, Ohio. The mold was fitted with a temperature recording apparatus to measure the air temperature of the interior of the mold. The mold was shuttled into the oven and rotated until the internal air temperature reached 250° C. The mold was then shuttled to a cooling chamber and immediately cooled with a combination of air and water to a temperature suitable for safe part removal.

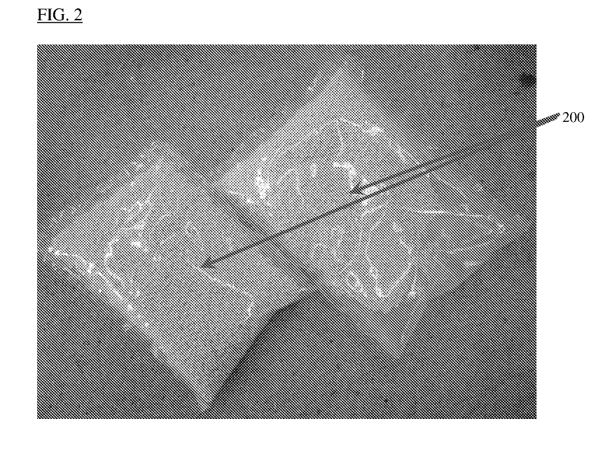

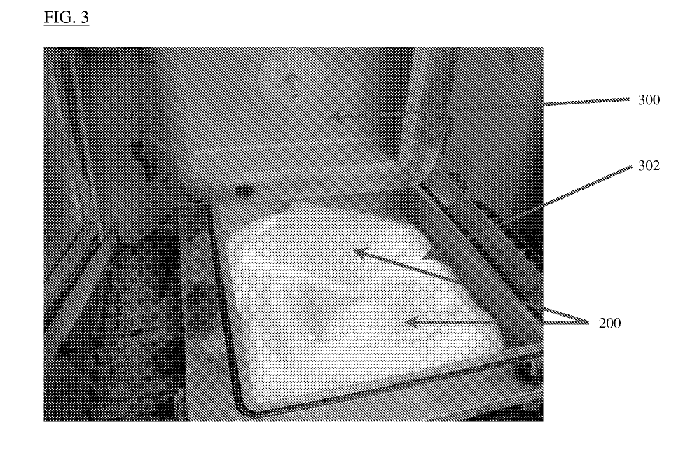

The procedure was repeated with the dried cPBT pellets sealed into two polyethylene bags (Uline #S1520 4 mil poly bag), shown in FIG. 2 (200). FIG. 3 depicts the rotational mold (300) initially charged with PE powder (302) and bagged cPBT (200).

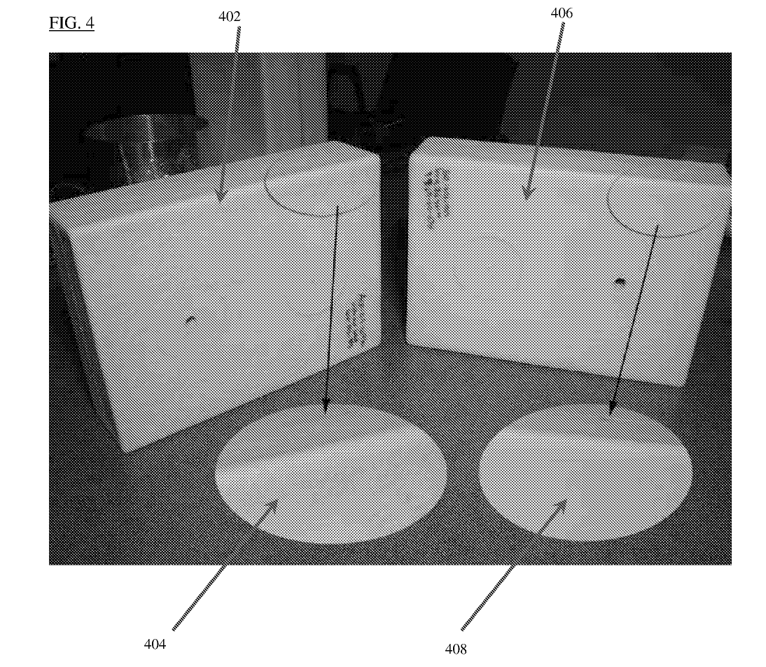

The double-layer box made with unbagged cPBT in the initial charge had a significant amount of embedded cPBT pellets in the outer PE layer. In contrast, the double-layer box made with bagged cPBT in the initial charge had virtually no embedded cPBT pellets in the outer PE layer. FIG. 4 shows the rotationally-molded box made with bagged and unbagged cPBT. The box on the left (402) was made with unbagged cPBT, the outer surface of which clearly shows embedded cPBT particles (404). The box on the right (406) was made with bagged cPBT, and the outer surface of this box is smooth and free of embedded cPBT particles (408).

Two-Layer Rotationally Molded Part: PE and Large Particle cPBT

A double-layer box with approximate dimensions 14″×10″×3.5″ was rotomolded with a single charge containing PE and unbagged cPBT particles. The same PE powder as used in the previous experiments was used in this experiment. However, the cPBT particles used in this experiment were larger than the ¼″-long, ⅛″-diameter commercially available CBT160® pellets. The larger cPBT particles used in this experiment were irregular, dry pieces broken from an approximately 1″ diameter strand collected from an extruder, (no water was adsorbed, so drying was not required). The large cPBT particles were approximately ¾″ to 1″ in length and approximately 1″ in diameter.

The rotomolding oven was preheated to 315° C. and the mold rotated at 4 rpm and 2.5 rpm on the major and minor axes, respectively, using the ROTO-Lab Model 30 rotational molding machine described above. The mold was fitted with a temperature recording apparatus to measure the air temperature of the interior of the mold. The mold was shuttled into the oven and rotated until the internal air temperature reached 250° C. The mold was then shuttled to a cooling chamber and immediately cooled with a combination of air and water to a temperature suitable for safe part removal, for example, from about 30 to about 40° C.

The double-layer box made with unbagged ¼″-long, ⅛″-diameter commercially available CBT160® pellets in the initial charge had a significant amount of embedded cPBT pellets in the outer PE layer, as shown in the left-hand box in FIG. 4, and described above. In contrast, the double-layer box made with large, unbagged ¾″ to 1″-long, 1″-diameter cPBT pieces in the initial charge had virtually no embedded cPBT pellets in the outer PE layer. The radius of the pieces were larger than the thickness of the PE layer approximately ⅛″ thick, and the size and/or weight of the particles were sufficient to allow the particles to “pull out” of the melting/melted PE layer as the mold rotated for a period of time, allowing the PE layer to coat the inside of the mold such that the surface of the finished box did not reveal embedded cPBT.

### EQUIVALENTS

While the invention has been particularly shown and described with reference to specific preferred embodiments, it should be understood by those skilled in the art that various changes in form and detail may be made therein without departing from the spirit and scope of the invention as defined by the appended claims. Insofar as this is a provisional application, what is considered applicants' invention is not necessarily limited to embodiments that fall within the scope of the claims below.

What is claimed is:

1. A method of manufacturing a multi-layer part, the method comprising the steps of:
(a) charging a rotational mold with at least the following:
a substantially non-oligomeric polymer for forming an exterior layer of the multi-layer part; and
particles comprising a macrocyclic polyester oligomer for forming an interior layer of the multi-layer part, wherein the particles comprising the macrocyclic polyester oligomer average at least about ⅛″ [3 mm] in at least one dimension; and
(b) rotating the mold, the mold having an elevated interior temperature.

2. The method of claim 1, wherein the particles comprising the macrocyclic polyester oligomer average at least about ¼″ [6 mm] in at least one dimension.

3. The method of claim 1, wherein the particles comprising the macrocyclic polyester oligomer average at least about ½″ [13 mm] in at least one dimension.

4. The method of claim 1, wherein the particles comprising the macrocyclic polyester oligomer average at least about ¾″ [19 mm] in at least one dimension.

5. The method of claim 1, wherein the particles comprising the macrocyclic polyester oligomer average at least about ⅛″ [3 mm] in at least one of the following: thickness, length, and diameter.

6. The method of claim 1, wherein the particles comprising the macrocyclic polyester oligomer are contained within one or more plastic bags.

7. The method of claim 6, wherein during step (b), the substantially non-oligomeric polymer begins to melt before the macrocyclic polyester oligomer and before the plastic bag.

8. The method of claim 1, wherein at least half of the particles comprising the macrocyclic polyester oligomer are larger in at least one dimension than the thickness of the exterior layer of the multi-layer part.

9. The method of claim 1, wherein the particles are substantially spherical.

10. The method of claim 1, wherein the particles are substantially cylindrical.

11. The method of claim 1, wherein the particles have an irregular shape.

12. A method of manufacturing a multi-layer part, the method comprising the steps of:
(a) charging a rotational mold with at least the following:
a substantially non-oligomeric polymer; and
a macrocyclic polyester oligomer, wherein the macrocyclic polyester oligomer is initially contained within one or more plastic bags; and
(b) rotating the mold, the mold having an elevated interior temperature.

13. The method of claim 12, wherein the substantially non-oligomeric polymer comprises at least one of the following: polyethylene, crosslinked polyethylene, polybutylene, polypropylene, polystyrene, polyethylene terephthalate, polybutylene terephthalate, polyamide, polyester, polyvinyl chloride, polycarbonate, acrylonitrile butadiene styrene, nylon, polyurethane, polyacetal, and polyvinylidene chloride.

14. The method of claim 12, wherein the macrocyclic polyester oligomer comprises a macrocyclic poly(alkylene dicarboxylate) oligomer having a structural repeat unit of the formula: 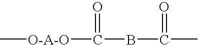
where A is an alkylene, or a cycloalkylene or a mono- or polyoxyalkylene group; and B is a divalent aromatic or alicyclic group.

15. The method of claim 12, wherein the macrocyclic polyester oligomer comprises at least one of the following: macrocyclic poly(butylene terephthalate) oligomer, macrocyclic poly(propylene terephthalate) oligomer, macrocyclic poly(cyclohexylenedimethylene terephthalate) oligomer, macrocyclic poly(ethylene terephthalate) oligomer, macrocyclic poly(1,2-ethylene 2,6-naphthalenedicarboxylate) oligomer, and copolyester oligomer comprising two or more monomer repeat units.

16. The method of claim 12, wherein the substantially non-oligomeric polymer comprises polyethylene and the macrocyclic polyester oligomer comprises macrocyclic poly(butylene terephthalate) oligomer.

17. The method of claim 12, wherein the melting temperature of the macrocyclic polyester oligomer is higher than the melting temperature of the non-oligomeric polymer.

18. The method of claim 12, wherein step (a) further comprises charging the mold with a filler.

19. The method of claim 18, wherein the filler comprises at least one of the following: a polymerization catalyst, a cross-linking agent, glass, glass fiber, milled glass fiber, glass microspheres, micro-balloons, stone, crushed stone, nanoclay, graphite, carbon nanotubes, carbon black, carbon fibers, buckminsterfullerene, anhydrous talc, fumed silica, titanium dioxide, calcium carbonate, wollastonite, chopped fiber, fly ash, linear polymer, monomer, branched polymer, engineering resin, impact modifier, organoclay, and pigment.

20.-30. (canceled)

31. A method of manufacturing a part with a scratch-resistant surface, the method comprising the steps of:
(a) contacting a surface of a rotational mold with melted macrocyclic polyester oligomer; and
(b) following step (a), introducing a substantially non-oligomeric polymer into the mold.

32. The method of claim 31, wherein step (a) comprises introducing solid particles comprising the macrocyclic polyester oligomer into the mold and melting the solid particles in the mold.

33. The method of claim 31, wherein step (a) comprises introducing melted macrocyclic polyester oligomer into the mold.

34. The method of claim 31, wherein step (b) comprises using a drop box to introduce the substantially non-oligomeric polymer into the mold.

35.-36. (canceled)

37. The method of claim 31, wherein the substantially non-oligomeric polymer comprises at least one of the following: polyethylene, crosslinked polyethylene, polybutylene, polypropylene, polystyrene, polyethylene terephthalate, polybutylene terephthalate, polyamide, polyester, polyvinyl chloride, polycarbonate, acrylonitrile butadiene styrene, nylon, polyurethane, polyacetal, and polyvinylidene chloride.
